(19) United States
(12) Patent Application Publication
(10) Pub. No.: US 2003/0086595 A1
(43) Pub. Date: May 8, 2003

(54) Display parameter-dependent pre-transmission processing of image data

(76) Inventors: Hui Hu, Waukesha, WI (US); Jiangsheng You, Auburndale, MA (US)

Correspondence Address: MORRISON & FOERSTER, LLP, 555 WEST FIFTH STREET, SUITE 3500, LOS ANGELES, CA, 90013-1024, US

(21) Appl. No.: 10/008,162

(22) Filed: Nov. 7, 2001

(51) Int. Cl. G06K 9/00; G06K 9/20

(52) U.S. Cl. 382/128; 382/282

(57) ABSTRACT

Greater efficiencies in the transmission of teleradiological image data can be achieved by pre-processing the image data on the server side so that unnecessarily large data packages are avoided. Such reduction in the size of data packages may be achieved by pre-converting the image data from a 16-bit format to an 8-bit format on the server side and by cropping the image data according to field of view settings before transmitting it. Combining these techniques with progressive refinement image processing greatly reduced the response time between requesting and image and having an image displayed to the user. Additional techniques for managing the transmission of image data include prioritizing image data requests and dynamically requesting additional image data as a user scans across an image.

### BACKGROUND OF THE INVENTION

The present invention generally relates to teleradiology systems. More particularly, this invention relates to improving the efficiency of transmitting image data used in a teleradiology system.

Teleradiology is a means for electronically transmitting radiographic patient images and consultative text from one location to another. Teleradiology systems have been widely used by healthcare providers to expand the geographic and/or time coverage of their service and to efficiently utilize the time of healthcare professionals with specialty and subspecialty training and skills (e.g., radiologists). The result is improved healthcare service quality, decreased delivery time, and reduced costs.

One drawback of existing modes of image data transmission is that image data is transmitted without regard to the settings of the device that will display the image. For example, many display devices reproduce images based on a gray-scale range of 8 bits per pixel, but image data is often provided in a 16 bits per pixel format. In conventional systems, when image data is transmitted to a display in a remote location, it is transmitted in a 16-bit format. The image data must then be converted to an 8-bit format before being displayed. This results in an inefficiency, because twice as much data as will be used is being transmitted, thus contributing to unwanted network congestion, and unnecessarily long delays between making a request for image data and having it displayed.

Another example of inefficiencies in existing modes of image data transmission is that they do not factor in other display settings such as the field-of-view (“FOV”). It is often true that a display device will show only a portion of the original image at one time, i.e., the FOV includes less than the entire image. For example, the original image data may be a 2048×2048 pixel image, but the display may be only capable of showing a 800×600 pixel image. In conventional teleradiology systems, the entire 2048×2048 data set is transmitted even though there is only an immediate need for data relating to the 800×600 pixel FOV. Similarly, conventional systems may begin to transmit all of a three-dimensional data set, even if only one two-dimensional slice is presently desired to be displayed. These are additional inefficiencies which increases network traffic and unnecessarily delay the display of a desired image.

Thus, it there is a present need for a technique for managing the transmission of image data in a manner which does not unnecessarily tax network resources by transmitting more data than is needed at any particular time.

### SUMMARY OF THE INVENTION

The present invention provides a pre-transmission processing technique which addresses all of the drawbacks described above. The present invention may be used in a client/server architecture, such as that described in our prior U.S. patent application Ser. No. 09/434,088, which is incorporated herein by reference. According one embodiment of the present invention, an image data set is processed before transmission according to the parameters set on a client display. If the display uses an 8-bit format, then a 16-bit format image data set will be converted to an 8-bit format on the server side before the image data is transmitted. Additionally, according to another embodiment of the present invention, the image data server will only transmit image data relevant to the FOV defined by FOV parameters set at the client. These two techniques alone significantly reduce the amount of data which must be transmitted over a network before an image can be displayed at a client. These techniques can also be combined with known techniques, such as progressive refinement using a wavelet transform, to yield even better performance.

The present invention also provides an image data transmission management system which controls the transmission of image data according to the needs of the user of a client computer. One of these image data transmission management techniques includes categorizing requested image data packages into priority classes and transmitting them according to their priority class. The image data transmission needs of a user may depend on how the user is viewing images on a client computer, e.g., whether the users is browsing images or navigating over an image as opposed to focusing in detail on a particular region for the purposes of a diagnosis or other analysis. The present invention also includes images data transmission management techniques which control the manner in which image data is processed and transmitted depending on how a user is viewing images.

### BRIEF DESCRIPTION OF THE DRAWINGS

FIG. 1 depicts a block diagram of a teleradiology system;

FIG. 2 is a table of values relating to prior art progressive refinement techniques;

FIG. 3 is a table of values relating to the progressive refinement techniques of the third embodiment of the present invention;

FIG. 4 is a table of values relating to the progressive refinement techniques of the fourth embodiment of the present invention;

FIG. 5 is a diagram depicting the relationship between sub-regions of an image.

FIG. 6 is a diagram depicting the relationship between and processing flow of requests for image data.

### DETAILED DESCRIPTION OF THE INVENTION

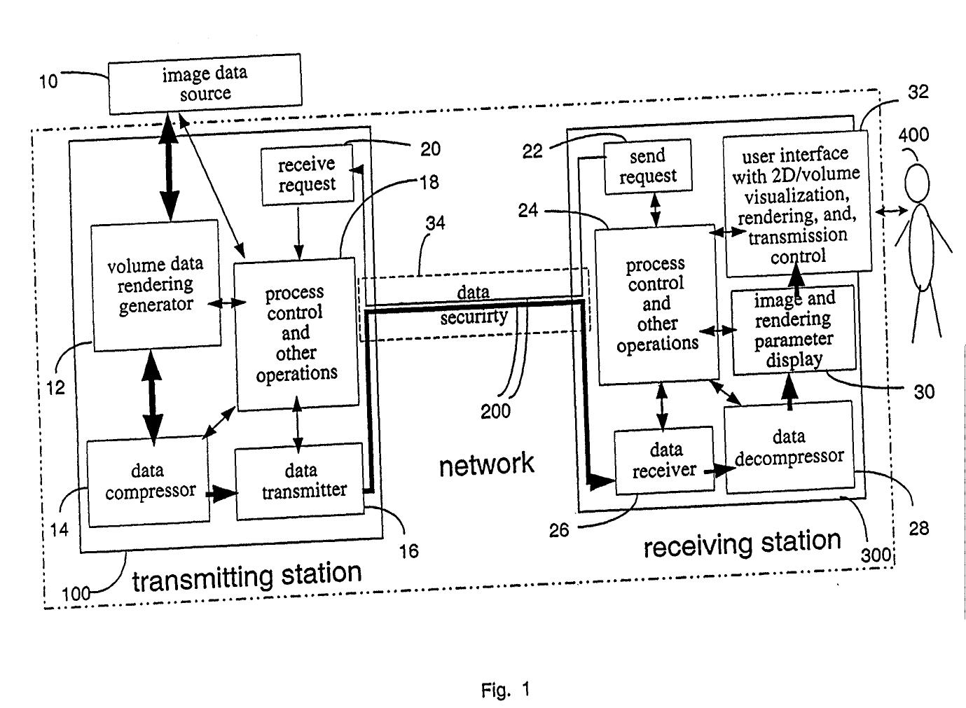

FIG. 1 depicts the teleradiology system described in our previous patent application, U.S. patent application Ser. No. 09/434,088. The teleradiology system includes an image data transmitting station 100, a receiving station 300, and a network 200 connecting the image data transmitting station 100 and receiving station 300. The system may also include a data security system 34 which extends into the image data transmitting station 100, receiving station 300, and network 200. Receiving station 300 comprises a data receiver 26, a send request 22, a user interface 32, a data decompressor 28, a display system 30, a central processing system 24, and, data security 34. The user interface may include a keyboard (not shown), a mouse (not shown), or other input devices. Transmitting station 100 comprises a data transmitter 16, a receive request 20, a data compressor 14, a volume data rendering generator 12, a central processing system 18, and, data security 34.

Image data is stored in the image data source 10. The image data may represent, for example, black-and-white medical images. The image data may be recorded with a gray-scale range of 16 bits per pixel. On the other hand, display devices, such as image display 30, may only be equipped to process a gray-scale range of 8 bits per pixel. The use of state parameters is described in my prior application, U.S. patent application Ser. No. 09/945,479, which is incorporated herein by reference. According to a first embodiment of the present invention, state parameters specifying a requested format, such as 8-bit format, and contrast/brightness settings of image display 30 are transmitted to the image data transmitting station 100 data along with a request for image data. This communication of data from the receiving station 300 (client) to the transmitting station 100 may be called a client request. The state parameters are received by the process controller 18 which determines that the receiving station has requested an 8-bit dynamic range. Accordingly, the process controller 18 directs the data compressor 14 to convert the 16-bit data associated with the requested image into an 8-bit format according to the transmitted state parameters. One manner of converting 16-bit image data into 8-bit image data is to use a lookup table that maps a ranges of values in the 16-bit representation to a value in the 8-bit representation.

Thus, even without applying other data compression techniques, the size of image data to be transmitted is reduced by 50% (8 vs. 16-bit). In fact, if data is further compressed, as it usually is, the size of compressed 8-bit image data will be less than 50%, typically 30-40%, of the corresponding compressed 16-bit image data. This is because the typical compression techniques work more effectively on 8-bit data than its 16-bit counterpart. Thus, this embodiment alone can reduce the system response time (defined as the time between requesting an image and displaying the requested (usually preview) image) by a factor of 2-3.

According to a second embodiment of this invention, image data is requested from the image data transmitting station 100 according to state parameters relating to the FOV setting of the image display 30. More specifically, image display 30 may be set to display only a portion (less than all) of the original image at one time. Thus, instead of having all of the original image data transmitted from image data transmitting station 100 to the receiving station 300, the user can request the transmission of only a part of the original image based either on default or user-selected FOV settings. For example, if the original image has 2048×2048 pixels and image display 30 is currently set to show only a part of it, e.g., 800×600 pixels, then only the part being displayed will be requested from the server. In the example just given, in which only a 800×600 pixel portion of a 2048×2048 pixel image is transmitted, this embodiment alone can reduce the system response time by a factor of 8.7, which is the ratio of the number of pixels in the original image to the number of pixels in the FOV of the display.

The first and second embodiments can be combined to provide a compounded reduction of the system response time equal to a multiplication of the individual reduction factors.

The first two embodiments, individually or jointly, can be integrated with the prior art technique of progressive refinement to achieve more reduction in system response time. Progressive refinement is the concept of dividing a package to be transmitted, denoted as Pᵢ, into N sub-packages, denoted as pᵢ^{j}, and sending these sub-packages sequentially, as represented by the following expression:

$${P}_{i} = {\sum }_{j = 1}^{j = N} {p}_{i}^{j} . \qquad ( 1 )$$

The package is usually divided and sent in such a way that reflects the order of approximation to the original package. In other words, the first sub-package, pᵢ¹, presents a crude (low resolution) approximation of the original package and is much smaller in size than the original package. The next sub-package, pᵢ², contains the next level of details, which, after combined with the lower order sub-package, presents a better approximation of the original package. As the imaging server sends more sub-packages, a better approximation of the original package can be formed at the receiving side. When all the sub-packages pᵢ^{j} are received, the original package Pᵢ can be faithfully reconstructed at the receiving side. Note that when N=1, it reduces to a single-progression transmission, i.e. the requested set of image data is transmitted all at once.

One way to subdivide the package for the above mentioned progressive transmission is to employ a wavelet-type transform. The wavelet transform is well known in the engineering field. There are numerous textbooks on this subject (for example “Wavelets and Filter Banks” by Gilbert Strang and Truong Nguyen).

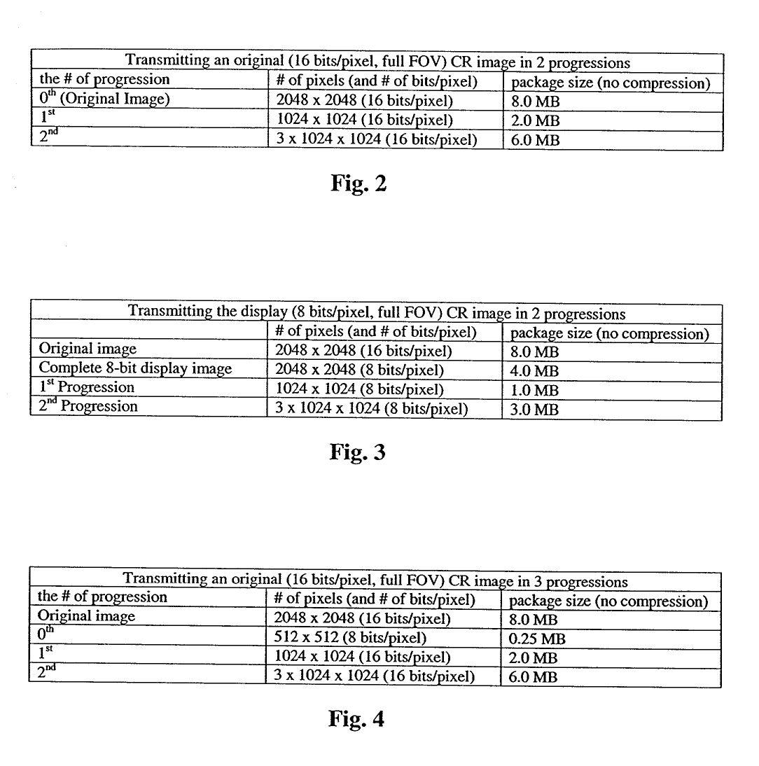

To further illustrate the progressive refinement using an example, consider transmitting a Computed Radiograph (CR) image, which is typically 8 MB (megabytes) in size. In the case of dividing the original image data package into 2 sub-packages using the two-dimensional wavelet-type transform, the size of each sub-package (before data compression) is listed in FIG. 2. As shown in FIG. 2, the size of the data set of first progression (2.0 MB) is one-fourth the size of the original data set, and will thus take one-fourth the time to transmit as the original data set. The first progression data set may be used to display a preview image while the second progression data set of 6.0 MB is being transmitted.

Certain radiological data, such as data from a CT (“computed tomography”) scan, contain several two-dimensional planes, or slices. From the user's 400 standpoint, he or she may simply have indicated through the user interface 32 that a particular image slices index is requested. This high-level request may be termed a user request. The high-level request may be implemented by the process controller 24 as several client requests for specific progressions or sub-packages of the requested image slice.

According to a third embodiment of the present invention, the progressive refinement techniques are combined with the first embodiment described above. In other words, the image data transmitting station 100 converts requested 16-bit image data into an 8-bit image data set which in turn is transmitted in multiple progressions. Using the example data illustrated in FIG. 2, the result of using the third embodiment is shown in FIG. 3. As shown, the original 16-bit data set is reduced in size by a factor of 2 by converting it into an 8-bit format. The 8-bit data set is then reduced by another factor of 4 when it is converted into the first progression image data set. The first progression image data set may be used to display a preview image of the complete 8-bit image. In the example just discussed, the third embodiment realizes a factor of 8 in reduction of response time. If a greater number of progressions are used, a further reduction in response time may be realized.

The first and third embodiments may be suitable for circumstances in which a user seldom changes the contrast or brightness settings. However, one consequence of these techniques is that a new image has to be ordered from the server 100 every time the contrast or brightness settings are changed. If a user needs to change the contrast or brightness settings frequently, it may be more desirable to transmit the entire full gray-scale range image from the image data transmitting station 100 to the receiving station 300. After that, the user can use the client-side computer at the receiving station 300 to generate a display image locally based on the current contrast/brightness settings.

Even when a full gray-scale range image must be transmitted, it may still be desirable to have a preview image available to be displayed before the complete image data are received. Reducing the system response time to display a preview image is also still desirable.

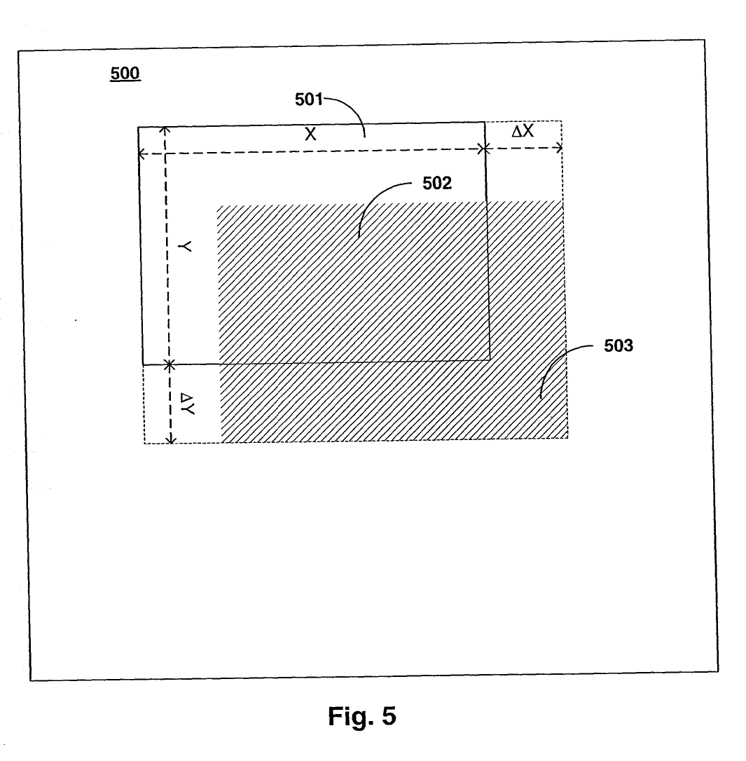

According to a fourth embodiment, the image data transmitting station transmits an 8-bit version of the requested image data before transmitting the full gray-scale 16-bit image data. Using the two-progression example illustrated in FIG. 2, we can precede the two-progression 16-bit image transmission with one 8-bit display image transmission. The results are summarized in FIG. 4 for 512×512 preview resolution. First a 1024×1024 pixel average value sub-image and three 1024×1024 pixel quadrant sub-images are created according to the two-dimensional wavelet transform. Then another 512×512 average value sub-image is created from the 1024×1024 pixel average value sub-image. This second sub-image will have a 16-bit format. To obtain the final 512×512 resolution preview image, the 16-bit data for the 512×512 average value sub-image is converted to 8-bit data. The 8-bit 512×512 pixel data set is used as a preview image data set. Although the 8-bit 512×512 pixel data set may be considered a “zeroth” order progression, note that the 8-bit 512×512 pixel data set is not used to reconstruct the original image data set (no inverse wavelet transform is applied to this data set). Rather, the 16-bit 1024×1024 pixel average value sub-image data set is the true first progression because the inverse wavelet transform will be applied to this data set and the three 1024×1024 pixel quadrant sub-images.

Note also that the 8-bit preview image transmission can precede a full gray-scale range image transmission with either single of multiple progressions, though only a two-progression transmission is exemplified in FIG. 4. Furthermore, the resolution of the 8-bit transmission can be coarser than the next progression (512×512 vs. 1024×1024) as exemplified in FIG. 4. Alternatively, the resolution of the preview image can also be equal to the next progression. In that case, rather than forming a 16-bit 512×512 average value sub-image from the 16-bit 1024×1024 average value sub-image, the 16-bit 1024×1024 average value sub-image can be directly converted to an 8-bit format and the resulting data set used as an 8-bit preview image.

The 8-bit (the 0^{th} order) transmission is an extra transmission in addition to the original full 16-bit gray-scale range transmission. Thus, it increases the overall package size accordingly (3%=0.25/8 for the example shown in FIG. 4). However, this slight increase in size is, in many cases, more than compensated by the fact that the time for getting the preview image is greatly reduced (by a factor of 32 in the example given in FIG. 4).

At different stages of a study, a user may need to make tradeoffs between system response time and the amount of information available. For example, when reviewing a large data set, the user may want to switch between two modes—the interactive and diagnosis modes. In the interactive mode, the user navigates through the data looking for the subject of interest. In this mode, navigation speed is more important to the user. Once the user finds something of interest, the user may want to switch to the so-called diagnosis mode in which the user will slow down or stop the navigation and perform a detailed examination. In the diagnosis mode, having as much detailed information as possible is the user's primary concern.

According to a fifth embodiment of the present invention, we propose to provide different and switchable study modes (e.g., the interactive and diagnosis modes) to meet these distinctively different needs. In a preferred embodiment, only 8-bit image data is transmitted in the interactive mode which increases the speed at which the user may navigate. In another preferred embodiment, the image resolution of the interactive mode can be slightly coarser than the optimal resolution for the diagnosis mode. For example, a 256×256 interactive resolution can be used for a 512×512 image resolution case. This can reduce the transmission time and/or the processing time. In a preferred embodiment of the diagnosis mode, a full gray-scale image will be provided at the optimal image quality. In a preferred embodiment, the interactive or diagnosis mode can be selected by pressing or releasing the left button of the mouse.

While reviewing multi-slice images, such as those from a CT scan, a user might want to preview other images before all the requested sub-packages of the currently displayed image are completely received. However, the user might want to complete the remaining requests for sub-packages of the currently displayed image in the background (i.e., when the computer and network resources are free), so that if the user comes back to this image later on, a better quality image will be readily available.

According to a sixth embodiment of the present invention, unfulfilled requests are put in a request pool. To make the system highly responsive to the user navigation, the following algorithm may be used to prioritize the requests that are in the request pool to be executed:

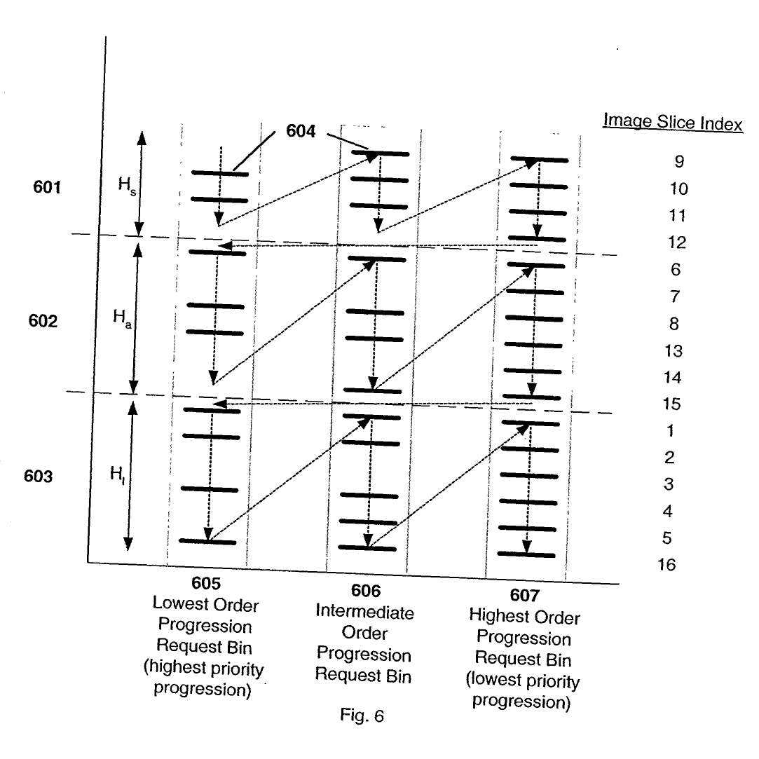

(1) The sub-package requests in the pool are categorized into several priority classes. Referring to FIG. 6, using a 3-class case as an example, those requests related to the images being displayed on the screen (Hₛ images) are categorized as the first priority class 601; those related to the images which are adjacent to the images on the screen (Hₐ images) are categorized as the second priority class 602; the remaining requests are categorized as the third (low) priority class 603 (Hₗ images). Furthermore, the sub-package requests that meet user-specified delete criteria (e.g., the sub-package requests that belong to a closed study) may be deleted from the request pool.

(2) The requests in the request pool are fulfilled according to their priority levels. The first priority class will be fulfilled the first, the second class the second, and so on.

(3) Within each priority class, the requests may be further grouped into bins based on the order (indexed as j in Equation (1)) of the sub-package. The requests are fulfilled according to their bin order, i.e., from the lowest order bin 605 to the highest order bin 607. In other words, the requests for sub-packages in the intermediate order bin 606 and the highest order bin 607 will not be fulfilled until all the requests from the lower order bins in a particular priority class, e.g., Hₛ, have been fulfilled.

This algorithm reflects an attempt to anticipate a likely browsing pattern of the user and to request data in accordance to the anticipated need. Image data relating to images that the user want to see now are given the highest priority. Next, the algorithm anticipates that images slices adjacent to those currently being viewed are mostly likely to be requested next, and requests for the image data relating to the adjacent images are made after all data for currently requested images have been received. Lowest priority is given to all other images. These requests for image data may be made in the background without a specific action taken by the user.

FIG. 6 is representative of a case in which progressive refinement in three progressions is used. For any given user request to view an image slice, the receiving station sends three client requests relating to three orders of progressions for the one image slice. The client request bars 604 in FIG. 6 represent unfulfilled client requests. The client request bars lying in a horizontal row represent client requests for different orders of progression of the same image slice.

Applying the algorithm above to the example in FIG. 6, the user has currently requested four images (with indices 9-12 indicated along the right side of FIG. 6) to be displayed on the screen. Therefore, all client requests relating to slice indices 9-12 are grouped in the first priority class 601, Hₛ. Images adjacent to slice indices 9-12, in this example, slices 6-8 and 13-15, are grouped in the second priority class 602, Hₐ. All other image slices, 1-5 and 16, are grouped in the third priority class 603, Hₗ.

The client requests in the first priority class 601 are sent first. Within the first priority class 601, the client requests 604 are further divided into lowest to highest order sub-package request bins 605-607. Referring to the first row of client requests 604 in the first priority class, which relates to image slice index 9, there is no client request 604 in the lowest sub-package request bin 605, and client requests 604 in each of the intermediate and highest order sub-package request bins 606, 607. This may reflect a situation in which a request to view image slice 9 had been previously made, and the first client request for the lowest order sub-package fulfilled. The image data relating to this previous request may still be stored in memory at the receiving station, and if so, the receiving station will not make a client request for this data again. Each time the user browses to another image, the priorities of the client requests may be reordered according to how the images slices are newly classified as Hₛ, Hₐ, and Hₗ images.

Referring to the next two rows, relating to image slice indices 10 and 11, there are client requests 604 in all three sub-package request bins 605, 606, 607, reflecting either that no previous requests to view these image slices have been made, or that the previously requested image data is no longer in memory. Referring to the fourth row, relating to image slice index 12, there is only one client request 604 in the highest order bin 607. This may indicate that a request to view slice 12 has been previously made, and that the first two progressions of the image were transmitted before the transmission was interrupted, perhaps by a client request that received a higher priority due to the user browsing to other slices.

Walking through the order of requests in the first priority class 601, first lowest order sub-package data is requested for slices 10 and 11, then intermediate order sub-package data is requested for slices 9-11, then highest order sub-package data is requested for slices 9-12. The system would then proceed to requests in the second and third priority classes 602, 603. The flow of the requests is depicted by arrows in FIG. 6.

According to a seventh embodiment of the present invention, the second embodiment (i.e., the limited FOV image transmission) may be integrated with user-interactive navigation. Referring to FIG. 5, data representing a full image 500 is provided or generated. The full image may be, for example, 2048×2048 pixels. However, while navigating an image, the user may only have a limited FOV that corresponds to the original image which is X pixels long and Y pixels wide, for example, an 900×700 pixel FOV. The initial browsing area defines a region of known data 501 because data relating to this area will have already been requested and transmitted to the receiving station for the purposes of displaying the current FOV. If the user changes the FOV to a new display region 502 so that there are some areas of the new display region 502 that lie outside of the region of known data 501, then additional data will be required. In other words, the prior region of known data 501 will have to be lengthened by ΔX and widened by ΔY, as shown in by the dotted outline in FIG. 5. Note that the completely unknown portions of new display region 502 may define an L-shaped region 503 (as is depicted in FIG. 5). However, rather than iteratively adding L-shaped regions to a current region of known data 501, it is often more practical to work with a rectangular region of interest. Thus, one method of practicing the invention includes expanding the region of interest in a manner which maintains a rectangular shape, even if the area of expansion is not immediately needed for the new display region 502.

An algorithm for growing the region of known data 501 can be described as follows, using as an example the navigation over a 2048×2048 pixel resolution CR image using a limited FOV that corresponds to original X×Y pixel region:

(1) Request and receive directly from the server the X×Y pixel image data for a first region of known data defined by initial field of view state parameters.

(2) If image data outside the boundaries of the previous region of known data is requested (e.g., due to the display shifting and/or zooming), define an expanded region of interest such that the length and width of the expanded region of interest encompasses both the region of image data being requested for the current FOV and the previous region of known data.

(3) Request and receive directly from the server the image data that is inside the expanded region of interest but is outside the previous region of known data.

(4) Combine the newly received image data with the image data in the previous region of known data in the memory.

(5) Redefine the expanded region of interest as the region of known data and repeat the step 2 as necessary.

With this algorithm, the region of known data will grow gradually and interactively. However, each time the region of know data expands, only data necessary for the incremental expansion is requested from the server. Requesting data only as needed according to the seventh embodiment reduces the system response time.

This concept can also be combined with the concept of progressive refinement. Using an example illustrated in FIG. 2, after completely transmitting first progression in one package, we can transmit the second progression interactively using the method described above.

Depending on network conditions, one of the preferred embodiments may be preferred over another. As one example of regulating the transmission settings, the client software may monitor the system response time. Based on this information, the software, e.g., the client-side software, may either suggest or automatically select to switch to one of the several transmissions methods described in the preferred embodiments above so that optimal system performance can be achieved. For example, if the network conditions are currently providing for rapid transmission of data, it may be desirable to use fewer progressions in the progressive refinement technique.

It should be understood by one of skill in the art that the techniques described herein may be implemented on computers containing microprocessors and machine-readable media, by storing programs in the machine-readable media that direct the microprocessors to perform the data manipulation and transmission techniques described. Such programs, or software, may be located in one or more of the constituent parts of FIG. 1 to form a client-server architecture which embodies the present invention.

While the present invention has been described in its preferred embodiments, it is understood that the words which have been used are words of description, rather than limitation, and that changes may be made without departing from the true scope and spirit of the invention in its broader aspects. Thus, the scope of the present invention is defined by the claims that follow.

What we claim is:

1. A method for transmitting image data comprising the steps of:
sending at least one client request for image data from a receiving station to an imaging server, the receiving station including a display device, said request including a transmission of state parameters representing one or more display device settings and one or more transmission settings;
generating the requested image data at the imaging server according to the display device settings; and
transmitting the generated image data from the imaging server to the receiving station based on the transmission settings.

2. The method of claim 1:
wherein one of the display device setting parameters includes a dynamic range of the display device; and
wherein the step of generating the requested image data further includes the step of converting the requested image data from a first format to a new format determined by the dynamic range of the display device.

3. The method of claim 1:
wherein one of the display device setting parameters includes a field of view; and
wherein the step of generating the requested image data further includes the steps of determining a cropped image area in accordance with the field of view and generating image data relating only to the determined cropped image area.

4. The method of claim 1:
wherein ones of the display device setting parameters includes a dynamic range of the display device and a field of view; and
wherein the step of generating the requested image data further includes the steps of
converting the requested image data from a first format to a new format determined by the dynamic range of the display device;
generating a cropped image area in accordance with the field of view; and
transmitting only the image data resulting from the steps of converting the requested image data and generating a cropped image area.

5. The method of claim 1 further including the step of generating at least two related client requests in response to a single user request.

6. The method of claim 5 wherein the step of generating at least two client requests is controlled by a communication system manager.

7. The method of claim 5 wherein one of the display device setting parameters includes a dynamic range of the display device.

8. The method of claim 5 wherein the display device setting parameters for a first one of the two or more related client requests include a dynamic range of the display device, the method further including the steps of:
converting the image data requested by the first client request from a first format to a new format determined by the dynamic range of the display device if the dynamic range is incompatible with the first format;
transmitting the converted image data from the imaging server to the receiving station based on the transmission settings;
for each of the other of the two or more related client requests besides the first, processing the requested image data in its first format to form one or more sub-packages of image data; and
transmitting each of the image data sub-packages from the imaging server to the receiving station.

9. The method of claim 1 wherein one of the display device setting parameters includes a study mode of the receiving station, the study mode being selected from the group comprising an interactive mode and a diagnostic mode.

10. The method of claim 9 further including the steps of:
determining whether the study mode is designated as interactive or diagnostic; and
if study mode is designated as interactive
(i) converting the requested image data from a first format to a new format determined by the dynamic range of the display device if the dynamic range is incompatible with the first format, and
(ii) transmitting the requested image data in its converted format from the imaging server to the receiving station; and
if study mode is designated as diagnostic, transmitting the image data in its first format from the imaging server to the receiving station.

11. The method of claim 9 further comprising the step of using the input from a computer input device to toggle the setting of the study mode between interactive and diagnostic.

12. A method for controlling requests for image data comprising the steps of:
generating a set of one or more related client requests for image data for each user request for an image slice in a three-dimensional data set to be displayed at a receiving station;
assigning request priorities to each set of one or more related client requests for each user request;
sending the client requests from a receiving station to an imaging server according to the request priorities assigned to each set of one or more related client requests.

13. The method of claim 12 wherein the step of assigning request priorities to each set of one or more related client requests further comprises the steps of:
assigning primary priority each set of the one or more related client requests that are related to user requests for an image slice which is being requests for current viewing at the receiving station;
assigning secondary priority to each set of the one or more related client requests that are related to user requests for image slices adjacent to the primary priority slice;
assigning tertiary priority to each set of the one or more related client requests that are related to user requests for all other image slices in the three-dimensional data set besides those with primary or secondary priority; and
placing pending client requests in a request queue in accordance with their was signed priority.

14. The method of claim 13 wherein each client request within each set of one or more related client requests is a request for one progressions of a multiple-progression transmission of image data, the method further including the steps of:
assigning a progression order level to each client request within the same priority class; and
sending the client requests within the same priority class from a receiving station to an imaging server according the progression order level.

15. The method of claim 3 further comprising the steps of:
transmitting the image data relating only to the determined cropped image area from the imaging server to the receiving station;
defining a region of known data according to the initial set of parameters designating the field of view;
determining a region of interest based on subsequent changes to the current region of known data;
sending a request for new image data outside the region of known data and inside the region of interest;
upon receiving the new image data, redefining the region of interest as a new region of known data.

16. The method of claim 15 wherein the step of redefining includes the step of expanding the dimensions of the region of interest lengthwise and widthwise such that the region of interest maintains a rectangular shape.

17. The method of claim 5 wherein one of the display device setting parameters includes a field of view, the method further comprising the steps of:
for at least one of the client requests, defining a region of known data according to the initial set of parameters designating the field of view;
determining a region of interest based on subsequent changes to the current region of known data;
sending a request for new image data outside the region of known data and inside the region of interest;
upon receiving the new image data, redefining the region of interest as a new region of known data.

18. A method for controlling the transmission of image data including the steps of:
monitoring the speed of the network connection of a receiving station;
altering the transmission settings of the receiving station in response to changes in the speed of the network connections; and
sending a client request for image data from a receiving station to an imaging server, said request including a transmission of state parameters including transmission settings.

19. The method of claim 18 wherein the transmission settings include a designation of the number of progressions which will be used to transmit an image.
